(19) United States
(12) Patent Application Publication
(10) Pub. No.: US 2021/0121364 A1
(43) Pub. Date: Apr. 29, 2021

(54) Four-Way Pill Splitter

(71) Applicant: Robert Stephens Davis, Los Angeles, CA (US)

(72) Inventor: Robert Stephens Davis, Los Angeles, CA (US)

(21) Appl. No.: 16/664,901

(22) Filed: Oct. 27, 2019

(51) Int. Cl. A61J 7/00

(52) U.S. Cl. CPC A61J 7/0007

(57) ABSTRACT

A pill splitter that cuts circular pills into four quarters and prevents a user from having to split a single pill, rotate the split pill, and split the pill again in order to obtain a fourth of a dose. The four-way pill splitter is composed of an upper and lower housing. The upper housing contains blades that meet at a vertex and the lower housing contains an inverted cone-shaped insert that the blades from the upper housing fit into so that the vertexes of the blades and the inverted cone-shaped insert only touch in the closed position.

### CROSS REFERENCES TO RELATED APPLICATIONS

Not applicable to this application

### STATEMENT REGARDING FEDERALLY SPONSORED RESEARCH OR DEVELOPMENT

Not applicable to this application

### BACKGROUND OF THE INVENTION

The Four-Way Pill Splitter is a simple device used to cut circular pills into four smaller equal-sized pieces. The device is intended for use within the medical field and for personal use at home. Prior to this device, only two-way pill splitters have been available on the market. With two-way pill splitters, a user who has been prescribed to take a ¼ of a pill must cut the pill in half using a two-way splitter, rotate the split pill, and then split the pill a second time to obtain ¼ of the original dosage. A four-way pill splitter has been patented (U.S. Pat. No. 6,968,987B1) but that four-way pill splitter lacks versatility by only providing a means to cut a specific sized pill solely. That four-way pill splitter additionally requires the use of three disconnected parts which can be cumbersome and susceptible to loss.

The Four-Way Pill Splitter was invented out of a need to lower the dosage of a prescribed medication by ¼. The device improved on current technology by reducing the splitting effort from three actions (cutting into ½, rotating, and cutting the half in half again to achieve ¼) into one action (cutting the pill into ¼). The Four-Way Pill Splitter also eliminates the human error inherent to rotating the halves of a pill that has already been split. This is a particular benefit to individuals with dexterity challenges who, unassisted, aren't able to handle and rotate small pills that have already been split in order to then split them again.

### BRIEF SUMMARY OF THE INVENTION

The Four-Way Pill Splitter is a device that cuts a circular pill of any size into ¼ with one action. It works by placing a pill in the center of an inverted cone-shaped insert, then compressing the top housing onto the bottom housing—the top housing being a lever arm extending radially from a fixed hinge connecting the two housings—until the two housings are coincident. Once the top hinge is returned to its starting position, the inverted cone-shaped insert will contain the pill now split into four quarters.

In accordance to the first aspect of the device, the Four-Way Pill Splitter is made up of an upper and lower housing connected by a rotating hinge.

In accordance with the second aspect of the device, the upper housing contains three cutting blades oriented to meet at a single vertex and form four 90-degree angles.

In accordance with the third aspect of the device, the lower housing contains an inverted cone-shaped insert, made of a rubber-like elastomer, that uses friction to secure a pill in place once the pill is placed into the device.

In accordance with the fourth aspect of the device, the inverted cone-shaped insert and the lower housing contain slits for the blades from the upper housing to fit within when the device is in the closed position.

### BRIEF DESCRIPTION OF THE DRAWINGS

FIG. 1—The Four-Way Pill Splitter made of constituent parts:

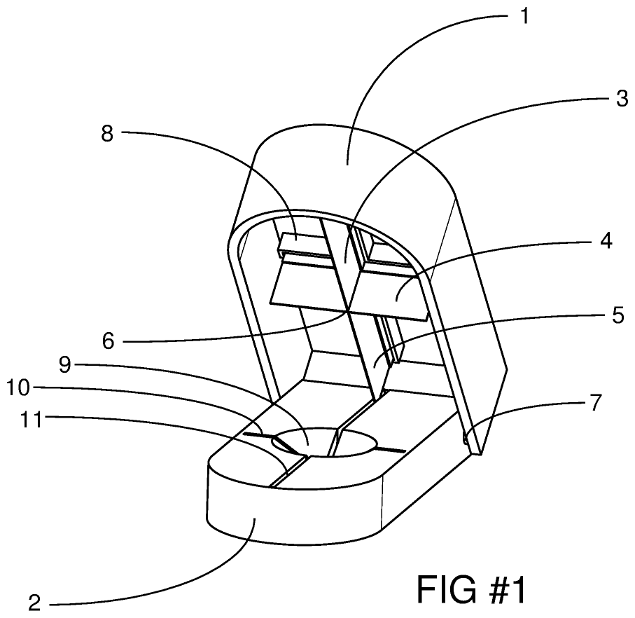

1—the upper housing which will be used as a lever arm
2—the lower housing
3—one blade placed parallel to the lever arm, a lengthwise blade
4—one blade placed perpendicular to the lever arm, the transverse blade
5—one blade placed parallel to the lever arm, a lengthwise blade
6—the vertex of 3 blades
7—the hinge/fulcrum made up of a peg from upper housing
8—slots in the upper housing to accommodate the 3 blades
9—an inverted cone-shaped insert into the lower housing made of a rubber-like elastomer
10—a slit to accommodate the transverse blade
11—a slit to accommodate the lengthwise blades

### DETAILED DESCRIPTION OF THE INVENTION

The Four-Way Pill Splitter device is made of out an upper housing 1 and a lower housing 2. Both housings are made out of plastic. Within the upper housing are three sharp blades: a first blade 3, a second blade 4, and a third blade 5. The first blade 3 and the third blade 5 are placed so that they are coplanar with their sharp edges colinear. The third blade 4 is placed in between the first two blades but is rotated to be perpendicular. The first blade 3 and the third blade 5 abut the second blade 4 at its midpoint. The edges of all three blades are coplanar and form a single vertex 6 containing four 90-degree angles. To make a convenient lever arm around the device's fulcrum 7, the first blade 3 and the third blade 5 are placed parallel to the lever arm while the second blade 4 is placed perpendicular to the lever arm. The blades sit in snugly designed pockets 8 within the upper housing 1. The vertex of the blades 6 is designed to strike the inverted cone-shaped insert 9 within the lower housing 2 (described below).

The lower housing is 2 contains an inverted cone-shaped insert 9. The insert is made out of a medically safe or food safe rubber-like elastomer material. The lower housing contains two slits: the short slit 10 which accommodates the second blade 4 and the long slit 11 which accommodates the first blade 3 and the third blade 5 when the device is in the closed position. Radiating out from the intersection of the slits is the insert 9 which is an inverted cone in shape. The shape of the insert allows any size pill to rest at the elevation where the diameter of the pill equals the diameter of the inverted cone. The insert is preferably made from a rubber-like elastomer material because these materials have a higher coefficient of friction than most plastics. This creates more friction between the pill and the device to hold the pill in place more securely during the splitting action. This leads to a cleaner cut from the blades.

The peg-and-hole hinge 7 is positioned on the housings so that 1) the collinear edges of the first blade 3 and the third blade 5 are also collinear to the center of the hinge 7 and 2) the intersecting vertex 6 of the blades will just strike the vertex of the inverted cone-shaped insert 9 at when the device is in a closed position. These constraints ensure the flattest approach for the blades toward the pill during the splitting action. This reduces uneven forces being applied to the pill which can cause it to shatter instead of split.

1) A device used to split circular pills into four congruent-sized quarters comprising:
a. an upper housing with embedded blades that meet perpendicularly at a vertex to form four supplementary 90-degree angles,
wherein the blades are thin flat surfaces approximately 0.010″ in thickness and sharpened to a point on an edge used for splitting;
b. a lower housing with two perpendicular slits to accommodate the blades;
c. wherein the upper housing and the lower housing are each constructed of plastic;
d. wherein the lower housing further comprises an embedded inverted cone-shaped insert made of a rubber, a plastic, or an elastomer that is medical-grade or food safe and holds a circular pill in place,
wherein the pill has an upper flat surface, a lower flat surface, and a third surface which is a cone between the upper flat surface and the lower flat surface; and wherein either the upper flat surface or the lower flat surface is configured to rest parallel to the base of the inverted cone-shaped insert;
e. wherein the upper housing and lower housing are joined at a hinge so that the vertex of the blades in the upper housing align squarely with the vertex of the slits in the inverted cone-shaped insert within the lower housing when the hinge is in a closed position, forcing the upper housing and the lower housing to be coincident.
